(19) United States
(12) Patent Application Publication
(10) Pub. No.: US 2005/0029412 A1
(43) Pub. Date: Feb. 10, 2005

(54) Wrist rest

(76) Inventor: Joseph R. Pearce, Princeville, HI (US)

Correspondence Address: FITZPATRICK CELLA HARPER & SCINTO, 30 ROCKEFELLER PLAZA, NEW YORK, NY, 10112, US

(21) Appl. No.: 10/635,512

(22) Filed: Aug. 7, 2003

(51) Int. Cl. B68G 5/00

(52) U.S. Cl. 248/118

(57) ABSTRACT

An ergonomic wrist rest in a novelty shape for use with a computer keyboard or mouse. The novelty shape includes stuffed animals or cartoon characters. The wrist rest has a central portion shaped as the torso of the character and peripheral portions shaped as the limbs, head and other extremities of the character. The central portion is formed with a moldable shape-retaining cushion sized to support the user's wrists while operating the keyboard or mouse. The wrist rest is positioned adjacent the keyboard and/or mouse by a lower layer of weighted materials, and/or by an outwardly extending platform on which the keyboard or mouse is operated.

### BACKGROUND OF THE INVENTION

1. Field of the Invention

The present invention pertains to an ergonomic wrist rest in a novelty shape for use with a computer keyboard or mouse. The novelty shape is a character such as a stuffed animal or cartoon character, with a central cushioned portion shaped as the torso of the character and peripheral stuffed portions shaped as the extremities of the character.

2. Description of the Related Art

Carpal tunnel syndrome and other repetitive stress injuries are known health hazards associated with extended use of computer input terminals, such as a computer keyboard or a mouse. One known approach for preventing such injuries, or for reducing symptoms of already existing injuries, is to provide an ergonomic wrist rest for the user which tends to level the user's wrist while operating the computer input terminal.

Some recent studies have suggested that work place stress can contribute to the onset and severity of these injuries. Accordingly, efforts have been undertaken to reduce work place stress. Those efforts have not led to a device as described herein, which provides an ergonomic wrist rest in a novelty shape, which tends to reduce stress by making use of the computer more enjoyable to the user.

### SUMMARY OF THE INVENTION

In one aspect, the invention is an ergonomic wrist rest for use adjacent to a computer input terminal such as a keyboard or mouse, comprising a soft body having an inner cavity and a three-dimensional outer covering, the inner cavity containing a moldable shape-retaining cushion, and the three-dimensional outer covering having a novelty appearance such as being shaped as an animal or a cartoon character.

In more detailed aspects, a wrist rest comprises a three-dimensional soft body shaped to resemble a character, wherein the soft body comprises a longitudinally extending central portion and at least one peripheral portion. The central portion is shaped as the torso of the character and is formed with a moldable shape-retaining cushion, the central portion being sized to cushion a user's wrist while the user is operating the computer input terminal. The peripheral portion is shaped as the extremities of the character, and is formed with a plush outer covering stuffed with a filling material. Representative exemplars of the character are cartoon characters or animals, and typically there are at least first and second peripheral portions, with the first being shaped as the head of the character and the second being shaped as the limbs or fins of the character.

Because of the novelty shape afforded by the wrist rest, use of the wrist rest is more enjoyable and/or soothing to the user, thereby reducing stress while affording the benefits of an ergonomically-shaped wrist rest.

Moreover, it has been found that the novelty shape makes the wrist rest attractive to users, making it more likely that the user will actually perform work when he/she is otherwise disinclined to do so. This is particularly true of younger users, and encourages such younger users to utilize educational software products in learning environments.

Further detailed aspects of the invention provide for a platform extending from a lower region of the central portion of the wrist rest, the platform being sized to support the computer input terminal. A non-skid surface may be formed on the surface of the platform, such as ridges or surface texturing that help position the wrist rest adjacent a keyboard with the platform underneath. Likewise, the surface of the platform may be provided with a tracking-enhanced surface, such as fabric or an optically neutral surface, so as to facilitate operation of a mouse on the surface thereof.

An attractive packaging is also provided, in which the extremities of the character are visible to a potential purchaser, and in which a target-shaped “bull's-eye” helps direct the purchaser's attention to the central cushioned portion.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

FIG. 1 is a plan view of a first embodiment of a wrist wrest according to the invention.

FIG. 2 is a cut-away elevational view of the FIG. 1 embodiment, along the line II-II′.

FIGS. 3 and 4 and are plan views of second and third embodiments of the invention, each featuring an extended platform.

FIG. 5 is a view showing packaging of the wrist rest.

### DETAILED DESCRIPTION OF THE PREFERRED EMBODIMENTS

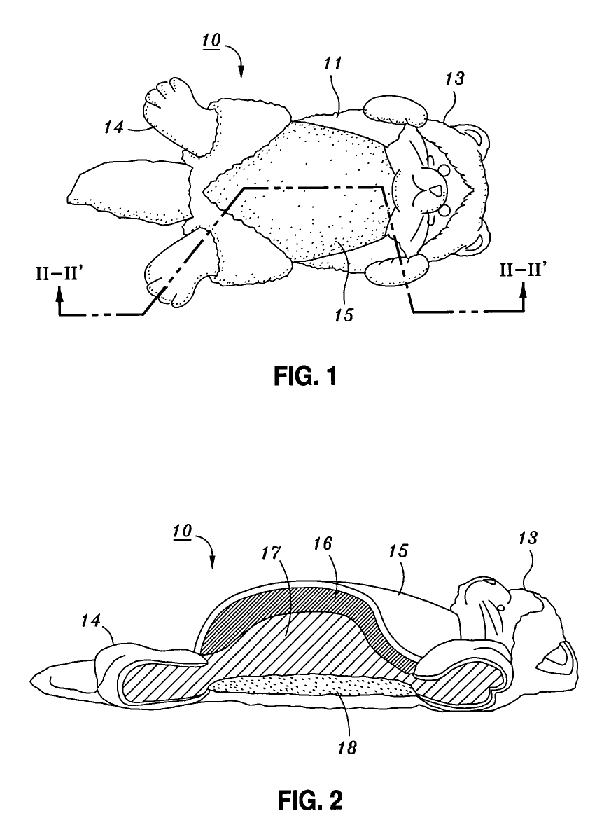

Referring to FIGS. 1 and 2, a wrist rest according to the invention includes a three-dimensional soft body 10 shaped to resemble a character, which in the case of FIGS. 1 and 2 is a supine cat. Soft body 10 includes a longitudinally extending central portion 15 shaped as the torso of the character, and first and second peripheral portions 13 and 14 shaped as extremities of the character. Here, peripheral portion 13 is shaped as the head and forward limbs of the cat, and peripheral portion 14 is shaped as the lower limbs and tail of the cat. The central portion is formed with a moldable shape-retaining cushion 15, which as shown in FIG. 2 is constructed from a gel cell 16 overlying a polyester fiber layer 17. The gel cell preferably is a silicon gel contained in a non-permeable membrane, and is covered with a smooth fabric-like material such as Lycra® brand fabric. Care should be taken to ensure that the gel material does not leak.

The peripheral portions are formed with a plush outer covering stuffed with a filling material such as the aforementioned polyester fiber. The plush outer covering adds to the three-dimensionality of the wrist rest, while promoting the overall enjoyable aspects of the novelty shape.

A layer 18 of weighted material such as PVC pellets may be provided so as to assist in positioning of the wrist rest adjacent the computer input terminal.

The wrist rest is sized to provide ergonomic support for the user's wrists. Preferably, the overall length of the wrist rest is approximately 9 or 10 inches, with cushion 15 being approximately 4 to 5 inches in length. Additionally, the overall width of the wrist rest is preferably around 3.5 to 4 inches wide, with cushion 15 being around 3 inches wide and approximately 1.5 inches high to provide adequate support to the wrist.

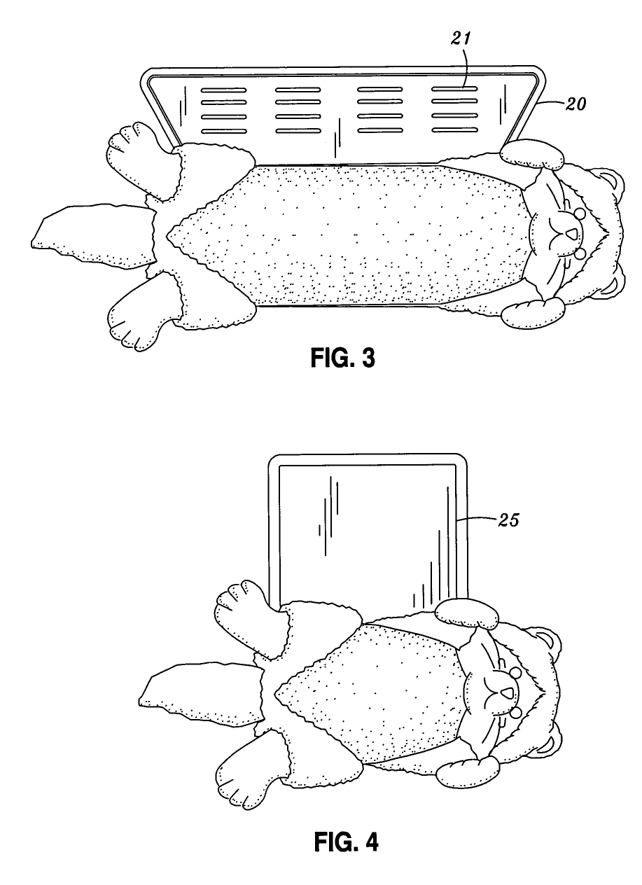

The embodiment of FIGS. 1 and 2 uses a layer 18 of weighted material so as to assist in positioning the wrist rest adjacent to the computer input terminal. FIGS. 3 and 4 show alternate embodiments, which both include a platform extending from a lower region of the central portion of the wrist rest, with the platform being sized to support the computer input terminal. The provision of an outwardly extending platform helps to position the wrist rest adjacent the computer input terminal, such that the layer 18 of weighted materials can be eliminated if desired. Otherwise, the internal construction of the embodiments shown in FIGS. 3 and 4 is substantially similar to that shown in FIG. 2.

Specifically, as shown in FIG. 3, platform 20 extends longitudinally adjacent the wrist wrest and includes a non-skid surface upon which a computer keyboard may be rested, so as to position the wrist rest adjacent the computer keyboard. Platform 20 preferably includes a non-skid surface, such as ridges 21 or other surface texturing. The non-skid surface helps to fix legs of the computer keyboard immovably on platform 20.

In FIG. 4, platform 25 is an outwardly extending mouse pad upon which a computer mouse may be operated. Preferably, the surface of platform 25 includes a tracking-enhanced texturing, such as being coated with a fabric or fabric-like material (which is suitable for a computer mouse equipped with tracking ball), or an optically neutral surface (which is suitable for an optical mouse).

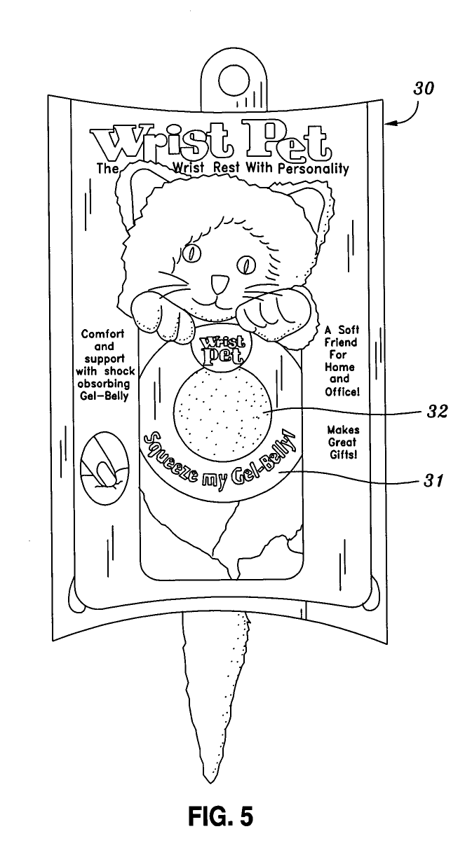

FIG. 5 shows a preferred packaging for the wrist rest, designed to showcase features of the wrist rest to potential purchasers. Packaging 30 is constructed to permit the extremities of the novelty shape to be clearly visible to the purchaser so as to allow the purchaser to select a particular one of plural different novelty shapes. In the FIG. 5 embodiment, the packaging allows the extremities to be completely exposed to the purchaser, such that the purchaser can touch exposed plush material. However, the packaging might enclose these extremities while permitting viewing from behind transparent material.

Packaging 30 also includes a central bull's eye region 31 with an open area 32 which permits the purchaser to touch the central portion, and particularly the shape-retaining cushion 15. Such an arrangement highlights the tactile and novel features of the product making it more attractive to purchasers.

In the foregoing embodiments, a supine cat has been used as exemplary of various characters into which the novelty shape might be formed. Such an example is not limiting, and other examples include other animals such as dog, bear, monkey, gecko, sea turtle, seal dolphin or whale. In addition, cartoon character shapes might be used. Naturally, in the case of aquatic figures, the extremities would correspond to head and fins, rather than head and limbs of land-based figures. In addition, although it is preferred that the character be supine, so that cushion 15 corresponds to the character's abdomen, it is possible to position the character in other poses, such as reclining, sitting, sideways, or face-down.

The invention has been described with respect to particular illustrative embodiments. It is to be understood that the invention is not limited to the above-described embodiments and that various changes and modifications may be made by those of ordinary skill in the art without departing from the spirit and scope of the invention.

1. A wrist rest for use adjacent to a computer input terminal, comprising a soft body having an inner cavity and a three-dimensional outer covering, said inner cavity containing a lower layer of weighted materials for positioning the wrist rest and a moldable shape-retaining cushion, and said three-dimensional outer covering having an appearance of a novelty character.

2. The wrist rest according to claim 1, wherein said three-dimensional outer covering is formed from a stretchable soft fabric-like material for contact with a user's wrist.

3. The wrist rest according to claim 1, wherein said novelty character has the appearance of a dog, cat, bear, monkey, gecko, sea turtle, seal, dolphin, whale or cartoon character.

4. The wrist rest according to claim 1, wherein said three-dimensional outer covering is stuffed with a filling material.

5. The wrist rest according to claim 1, further comprising an outwardly extending platform from a lower region of the wrist rest.

6. (Cancelled)

7. The wrist rest according to claim 1, wherein said wrist rest has a length of approximately 7 to 10 inches.

8. The wrist rest according to claim 1, wherein said wrist rest has a width of 2 to 5 inches.

9. A wrist rest constructed for use adjacent a computer input terminal comprising a three-dimensional soft body shaped to resemble a character, wherein said soft body comprises:
a longitudinally extending central portion shaped as the torso of the character and formed with a lower layer of weighted materials for positioning the wrist rest and a moldable-shape-retaining cushion, said central portion being sized to cushion a user's wrist while the user is operating the computer input terminal; and
at least one peripheral portion shaped as an extremity of the character and formed with a plush outer covering stuffed with a filling material.

10. The wrist rest according to claim 9, wherein the character is an animal, and further comprising first and second peripheral portions, the first peripheral portion being shaped as the head of the animal and the second peripheral portion being shaped as a limb or fin of the animal.

11. The wrist rest according to claim 10, wherein the animal is a dog, cat, bear, monkey, gecko, sea turtle, seal, dolphin, whale or cartoon character.

12. The wrist rest according to claim 9, wherein the character is a cartoon character.

13. The wrist rest according to claim 9, wherein the central portion includes an internal gel cell covered with a fabric-like material.

14. The wrist rest according to claim 9, further comprising a platform extending from a lower region of the central portion of the wrist rest, said platform being sized to support the computer input terminal.

15. The wrist rest according to claim 14, wherein the platform is constructed with a non-skid surface constructed to fix a computer keyboard.

16. The wrist rest according to claim 14, wherein the platform has a tracking enhanced surface constructed for operation with a computer mouse.

17. (Cancelled)

18. The wrist rest according to claim 9, wherein a length of the wrist rest is approximately 7 to 10 inches.

19. The wrist rest according to claim 9, wherein the width of the wrist rest is approximately 2 to 5 inches.

20. (Cancelled)

21. A wrist rest according to claim 1, wherein said lower layer of weighted materials positions said wrist rest so that the novelty character is in a supine position.

22. A wrist rest according to claim 9, wherein said lower layer of weighted materials positions said wrist rest so that the character is in a supine position.
